(19) United States
(12) Patent Application Publication
(10) Pub. No.: US 2004/0082468 A1
(43) Pub. Date: Apr. 29, 2004

(54) Ceramic catalyst

(75) Inventors: Takumi Suzawa, Okazaki-city (JP); Tomohiko Nakanishi, Kariya-shi (JP); Hideaki Ueno, Okazaki-shi (JP); Hiromasa Suzuki, Toyota-shi (JP)

Correspondence Address: NIXON & VANDERHYE, PC, 1100 N GLEBE ROAD, 8TH FLOOR, ARLINGTON, VA, 22201-4714, US

(73) Assignees: DENSO CORPORATION, Aichi-pref (JP); NIPPON SOKEN, INC., Aichi (JP)

(21) Appl. No.: 10/685,568

(22) Filed: Oct. 16, 2003

(30) Foreign Application Priority Data
Oct. 17, 2002 (JP) 2002-302597
Aug. 28, 2003 (JP) 2003-304188

(51) Int. Cl. B01J 23/10

(52) U.S. Cl. 502/302; 502/439

(57) ABSTRACT

To provide a ceramic catalyst having both promoter activity and heat resistance at a small amount of promoter component and also having a low pressure drop and a low heat capacity, a noble metal as a catalyst component and at least two layers of promoter components having oxygen storage capacities are supported on a ceramic carrier which is prepared by replacing a part of component element of the ceramic material such as cordierite to enable to support a catalyst component directly thereon. The outermost layer consists of a promoter component having the highest heat resistance, and the innermost layer consists of a promoter component having the highest oxygen storage capacity, which improve heat resistance without increasing an amount of supported promoter component.

### BACKGROUND OF THE INVENTION

1. Field of the Invention

The present invention relates to a ceramic catalyst suitably used as, for example, a catalyst for purifying the exhaust gas of an automobile engine.

2. Description of the Related Art

A catalyst for purifying an exhaust gas, such as a three way component catalyst, generally comprises a ceramic carrier such as a cordierite honeycomb structure having high thermal shock resistance, a coated layers, such as γ-alumina, formed on a surface of the ceramic carrier, and a supported noble metal catalyst component. However, formation of a coated layer results in faults such as increases in pressure drop and in heat capacity. Therefore, methods for supporting a catalyst component without forming a coated layer have been studied in recent years. For example, a method of supporting a catalyst component on cordierite having a specific surface area improved by treating the cordierite with acid, and thereafter heat-treating it, is known.

Moreover, a ceramic carrier capable of supporting a catalyst component directly on a surface thereof, which is prepared by replacing a component element of a ceramic material with an element having a different valence to form lattice defects in the crystal lattice of the ceramic material, has been proposed (for example, Japanese Unexamined Patent Publication No. 2001-310128). This ceramic carrier can support a catalyst component in cavities resulting from the lattice defects, and therefore it is not necessary to form the coated layer on it and it has an effect of decreasing pressure drop and the heat capacity. Moreover, there is no possibility of a strength decrease due to the formation of cavities, and it can be expected to be applied to a catalyst, for purifying an automobile exhaust gas, which needs durability.

A catalyst may comprise various promoter components, in addition to a noble metal component, in order to improve the catalytic performance. For example, a three way component catalyst uses a promoter component having oxygen storage capacity, such as CeO₂. The promoter component extends a range (window) of high purification performance utilizing its characteristics of absorbing and desorbing oxygen near the stoichiometric air fuel ratio. Attempts to improve purification performance have been made by using a ceramic carrier capable of supporting the above-mentioned catalyst component directly, supporting a noble metal catalyst component on it, and then supporting a promoter component having oxygen storage capacity.

However, although CeO₂ has an excellent oxygen storage capacity, it has a poor heat resistance. For this reason, in order to obtain a desired performance, it is necessary to increase a supported amount, which results in increases in the heat capacity and the pressure drop. Moreover, addition of a highly heat-resistant Ce-Zr multiple oxide may decrease a total amount of supported promoter components, and the heat resistance improves, but there is a problem that an oxygen storage capacity decreases. Therefore, it is required that both an oxygen storage capacity and heat resistance should be obtained although an amount of supported promoter components is smaller.

### SUMMARY OF THE INVENTION

The present invention aims at providing a ceramic catalyst having a high catalytic performance and utility, which has both an oxygen storage capacity and heat resistance although an amount of supported promoter components is smaller and can decrease a heat capacity and a pressure drop and which can exert various catalyses depending on use.

In one embodiment, the invention is a ceramic catalyst comprising a ceramic carrier capable of supporting a catalyst component directly on a surface thereof, a catalyst component supported on a surface of the ceramic carrier, and at least two layers of promoter components formed on the ceramic carrier, wherein an outermost layer of the layers comprises a promoter component having the highest heat resistance among the promoter components.

Thus, a heat resistance can be improved by using two or more promoter components and forming the outermost layer exposed to exhaust gas with a promoter component having the highest heat resistance. Thereby, an inner layer can comprise a promoter component having a poor heat resistance but an excellent promoter performance, and, therefore, a catalytic performance can be obtained without increasing an amount of supported promoter components. Consequently, a highly efficient ceramic catalyst having a low pressure drop and a low heat capacity can be obtained.

In another embodiment, the ceramic carrier may have many pores, and an innermost layer of the layers of promoter components may be formed on inner surfaces of the pores. By supporting a promoter component inside the pores, an amount of supported promoter components can be increased while increase in a pressure drop is reduced. Moreover, as a promoter component is close to catalyst components on inner surfaces of the pores, a catalytic performance improves.

In another embodiment, the ceramic carrier may have many pores, and an innermost layer of the layers of promoter components may be formed on inner surfaces of the pores as well as on an outer surface of the ceramic carrier. Also in this embodiment, a catalytic performance can be effectively improved by supporting a promoter component inside the pores although an amount of supported promoter components is small.

In another embodiment, at least one of the promoter components may comprise an oxygen storage component. An oxygen storage component can move oxygen in and out depending on oxygen concentration, and can enhance an activity of a catalyst component.

In another embodiment, the oxygen storage component may be an oxide or multiple oxide comprising at least one element selected from the group consisting of lanthanoides, Y, Zr and Hf. A desired good oxygen storage capacity is obtained by suitably selecting from these oxides and multiple oxides.

In another embodiment, the outermost layer of the layers of promoter components may comprise a Zr-rich ceria/zirconia solid solution. As heat resistance is improved by adding zirconia to ceria as a solid solution, it is suitably used as the outermost layer.

In another embodiment, an innermost layer of the layers of promoter components may comprise a ceria or a Ce-rich ceria/zirconia solid solution. The higher a content of ceria is, the more an oxygen storage capacity is improved. Therefore, it is suitably used as the innermost layer.

In another embodiment, the ceramic catalyst may comprises three layers of promoter components, an innermost layer of the layers comprises a ceria, an intermediate layer of the layers comprises a Ce-rich ceria/zirconia solid solution, and an outermost layer of the layers comprises a Zr-rich ceria/zirconia solid solution. When the ceramic catalyst comprises three layers of promoter components, it is effective to place the layers so that heat resistance may become higher from the inner layer to the outer layer.

In another embodiment, the ceramic carrier may comprise a ceramic material, and a part of the atoms of at least one component element of the ceramic material are replaced by atoms of a non-component element, and the catalyst component is supported on the non-component element. By suitably selecting a non-component element replacing the component element(s) of the ceramic material, the bond to a catalyst component can be strengthened, and it is possible to obtain a catalyst which cannot deteriorate easily.

In another embodiment, the catalyst component may be supported on the non-component element by chemical bond. As a chemical bond increases retentivity and a catalyst component becomes hard to aggregate, deterioration of the catalyst component is inhibited and the catalyst component can maintain a large surface area over a long period of time.

In another embodiment, the non-component element may be at least one element having a d or f electron orbit. An element having a d or f electron orbit can improve bonding strength as it is easily bonded to a catalyst component.

In another embodiment, the ceramic carrier may comprise a ceramic material selected from the group consisting of cordierite, alumina, spinel, mullite, aluminum titanate, zirconium phosphate, silicon carbide, zeolite, perovskite, and silica-alumina.

In another embodiment, the ceramic carrier may have many cavities and the catalyst component can be supported directly in the cavities.

In another embodiment, the cavities may comprise at least one of defects in a ceramic crystal lattice, fine cracks of ceramic surface, and deficiencies of atoms of component element of the ceramic material.

In another embodiment, the width of the fine cracks may be not more than 100 nanometers, which is preferable to secure the hardness of the carrier.

In another embodiment, the cavities may have a diameter or width of not more than 1000 times as long as that of an ion of the catalyst component supported. Here, when there are not less than 1×10¹¹ cavities per liter, the same amount of catalyst component can be supported as on the former.

In another embodiment, the ceramic material may comprise cordierite, and the cavities may comprise defects formed by replacing a part of component element of the cordierite with a metallic element having a different valence. Since cordierite is excellent in a thermal shock resistance, it is suitable as a catalyst for automobile exhaust.

In another embodiment, the defects may comprise at least one of oxygen defects and lattice defects. When the cordierite contains not less than 4×10⁻⁶ percent of cordierite crystals having at least one defect in a unit crystal lattice, the same amount of catalyst component can be supported as on the former.

In another embodiment, the ceramic carrier may be in at least one shape selected from the group consisting of honeycomb, pellet, powder, foam, fiber, and hollow fiber. An optimal shape can be selected depending on a use.

### BRIEF DESCRIPTION OF THE DRAWINGS

FIG. 1 is an illustrative sectional view of a surface part of one embodiment of a ceramic catalyst according to the present invention.

FIG. 2 is an illustrative sectional view of a surface part of a conventional ceramic catalyst.

FIG. 3 is an illustrative sectional view of a surface part of another embodiment of a ceramic catalyst according to the present invention.

FIG. 4 shows the effect of the present invention, and illustrates fresh and aged amounts of stored oxygen in Example 1 using a ceramic catalyst having two layers of promoter components in comparison with Comparative Examples 1 and 2 using a ceramic catalyst having only one layer of promoter component.

### DETAILED DESCRIPTION OF THE INVENTION

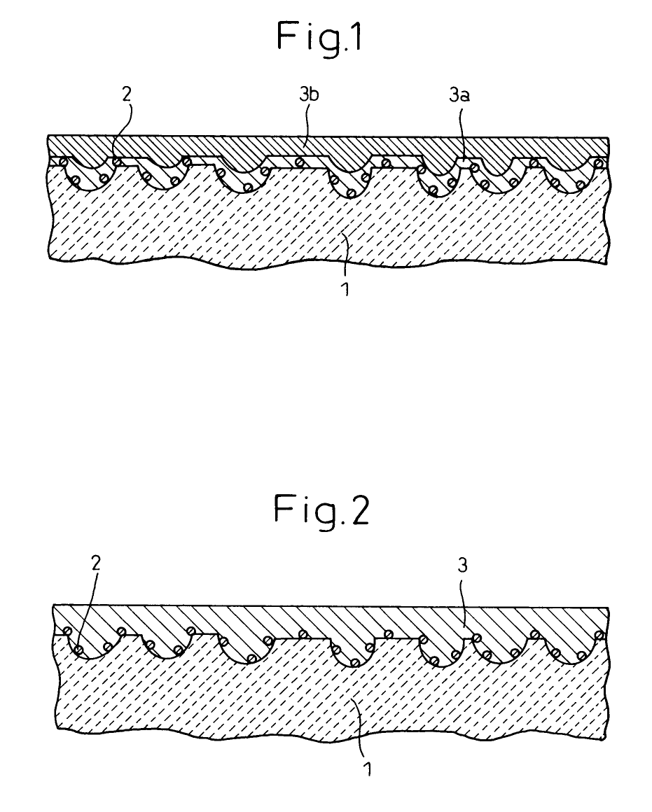

Hereafter, the present invention will be explained with reference to the drawings. FIG. 1 is an illustrative sectional view of a surface part of one embodiment of a ceramic catalyst according to the present invention, which can be suitably used as, for example, a catalyst for purifying automobile exhaust gas. A ceramic catalyst of the present invention comprises a ceramic carrier 1 capable of supporting a catalyst component directly on a surface thereof, which is hereinafter referred to as a direct-supporting ceramic carrier, and comprises a catalyst component 2 and promoter components supported on the direct-supporting ceramic carrier 1. The present invention employs two or more promoter components, which, in order, are laminated to form promoter layers 3a, 3b.

As a ceramic material for the ceramic carrier, a material based on cordierite having a stoichiometric composition expressed by 2MgO. 2Al₂O₃.5SiO₂ is suitably used for a catalyst for purifying exhaust gas, which requires high heat resistance. Moreover, a ceramic material selected from alumina, spinel, mullite, aluminum titanate, zirconium phosphate, silicon carbide, zeolite, perovskite, silica-alumina, and the like may be used other than cordierite. As to the shape of the carrier, a honeycomb is preferable for a catalyst for purifying automobile emission gas. Pellets, a powder, a foam, fibers, hollow fibers, and the like, can be used in addition to a honeycomb.

Specifically, a direct-supporting ceramic carrier has many atoms of an element having a large bonding strength to a catalyst component on a surface thereof, and is capable of supporting a catalyst component directly on a surface thereof by bonding a catalyst component chemically to these atoms of the element without a coated layer such as γ-alumina or the like. An element capable of directly supporting a catalyst component is an element other than an element or elements constituting a ceramic material of a ceramic support, and is an element capable of bonding chemically to a catalyst component. An element constituting a ceramic material of a ceramic support is hereinafter referred to as “a component element” and an element other than the component elements is referred to as “a non-component element.” A non-component element is introduced into a ceramic material by replacing a part of atoms of at least one component element of the ceramic material by atoms of a non-component element. For example, in the case of cordierite, a non-component element is different from Si, Al and Mg which are the component elements of cordierite except oxygen. Preferably, a non-component element is an element having a d or f electron orbit, more preferably an element having an unoccupied d or f electron orbit or having two or more oxidation states. An element having an unoccupied d or f electron orbit has a similar energy level as a supported catalyst component, especially a noble metal, and donates electrons easily. Therefore, it tends to bond to a catalyst component. An element having two or more oxidation states also donates electrons easily to a catalyst component and tends to bond to a catalyst component.

Examples of an element having an unoccupied d or f electron orbit include W, Ti, V, Cr, Mn, Fe, Co, Ni, Zr, Mo, Ru, Rh, Ce, Ir, Pt, and the like. One of these elements may be used alone, and two or more of them may be used in combination. Among these elements, W, Ti, V, Cr, Mn, Fe, Co, Mo, Ru, Rh, Ce, Ir, and Pt are elements having two or more oxidation states. In particular, W and Co are preferably used. In addition to these elements, examples of an element having two or more oxidation states include Cu, Ga, Ge, Se, Pd, Ag, Au, and the like.

In order to replace a component element of a ceramic material with a non-component element, when preparing a raw material of the ceramic material, a raw material of the non-component element may be added to a raw material of the ceramic material and be kneaded. In this case, an amount of the replaced component element in the raw material is beforehand reduced according to the replaced proportion. Subsequently, the kneaded raw material is molded and dried by a usual method, and then is degreased and calcined in atmospheric air. Alternatively, a component element may be replaced with a non-component element by preparing a raw material of the ceramic material in which an amount of a raw material of the replaced component element is beforehand reduced according to the replaced proportion, and kneading, molding and drying by a usual method, and thereafter immersing it in a solution containing a non-component element. The immersed molded material is taken out from the solution and dried, and then is degreased and calcined in atmospheric air. Such an immersing method is more effective since many atoms of a non-component element exist on a surface of the molded material and thus during calcination elements are easily replaced on the surface to produce a solid solution.

0.01 to 50 percent, preferably 5 to 20 percent, of atoms of a replaced component element may be replaced by atoms of a non-component element. In addition, when a non-component element has a valence different from a component element of a ceramic material, lattice defects or oxygen defects are produced according to the difference of valence. However, if two or more replacing non-component elements are used and the total oxidation number of the replacing non-component elements is adjusted to be equal to the total oxidation number of the replaced component element, defects will not be produced. Therefore, if production of defects is not desired, it is preferable to adjust so that there may be no change of valence, as a whole, in this way.

A ceramic carrier having on a surface thereof many cavities which are capable of directly supporting a catalyst component can also be used as a direct-supporting ceramic carrier. Cavities capable of directly supporting a catalyst component specifically result from at least one of defects in a ceramic crystal lattice (oxygen defects or lattice defects), fine cracks of ceramic surface, and deficiencies of atoms of a component element of a ceramic material, and a combination thereof. Since diameters of ions of a supported catalyst component are generally about 0.1 nanometers, a cavity on a surface of a ceramic carrier is capable of supporting an ion of a catalyst component if a diameter or width of the cavity is not less than 0.1 nanometers. To secure the hardness of a ceramic material, a diameter or width of the cavity is not more than 1000 times as large as that of an ion of a catalyst component, that is to say, 100 nanometers, and it is preferred that it is as small as possible. More preferably, it is one to 1000 times as large as that, namely 0.1 to 100 nanometers. A depth of a cavity is preferably not less than a half of a diameter of an ion of a catalyst component, namely 0.05 nanometers, in order to retain it. In case of such a size, in order to enable to support the same amount (1.5 grams per liter) of catalyst component as the former, the number of cavities per liter may be not less than 1×10¹¹, preferably not less than 1×10¹⁶, more preferably not less than 1×10¹⁷.

Defects in a crystal lattice include an oxygen defect and a lattice defect (a metal vacancy and lattice strain). An oxygen defect is a defect produced by lack of oxygen constituting a ceramic crystal lattice, and a catalyst component can be supported in a cavity formed by missing oxygen atoms. A lattice defect is a defect produced by incorporating oxygen more than an amount necessary for constituting a ceramic crystal lattice, and a catalyst component can be supported in a cavity formed by lattice strain or a metal vacancy.

Specifically, the above-mentioned number of cavities are obtained when cordierite contains not less than 4×10⁻⁶ percent, preferably not less than 4×10⁻⁵ percent of cordierite crystals having at least one oxygen defect or lattice defect in a unit crystal lattice, or contains not less than 4×10⁻⁸, preferably not less than 4×10⁻⁷ oxygen defect or lattice defects per unit crystal lattice.

As to methods of forming such cavities, for example, oxygen defects in a crystal lattice are formed by 1) calcining under a reduced pressure or under reducing atmosphere in a calcination step after a raw material, for example, of cordierite including Si, Al and Mg sources, is molded and degreased, 2) making oxygen run short in calcination atmosphere or in a starting material by using a compound containing no oxygen as at least a part of a raw material and calcining in low oxygen concentration atmosphere, or 3) replacing a part of at least one of component elements of a ceramic material other than oxygen with an element having a smaller valence. In the case of cordierite, the component elements are Si(4+), Al(3+), and Mg(2+), which have positive charges. When the component elements are replaced by an element having a smaller valence, positive charges equivalent to a valence difference between a replaced element and a replacing element multiplied by an amount of replaced element run short. Then, in order to maintain the electroneutrality of a crystal lattice, O(2−) having a negative charge leaves the crystal lattice to form oxygen defects.

Lattice defects can be formed by replacing a part of component elements of a ceramic material other than oxygen by an element having a larger valence. When a part of Si, Al, and Mg which are the component elements of cordierite are replaced by an element having a larger valence, positive charges equivalent to a valence difference between a replaced element and a replacing element multiplied by an amount of replaced element become excessive. Then, in order to maintain the electroneutrality of a crystal lattice, the crystal lattice introduces a required amount of O(2−) having a negative charge. The introduced oxygen prevents a cordierite crystal lattice from locating regularly, and a lattice strain is formed. In this case, a molded ceramic material is calcined in atmospheric air so that oxygen may be sufficiently supplied. Alternatively, sometimes some of Si, Al and Mg atoms come out to form holes in order to maintain electroneutrality. As the size of these defects is considered to be not more than several angstroms, the size cannot be measured as a specific surface area by a usual method of measuring a specific surface area such as a BET adsorption method using nitrogen molecules.

The number of oxygen defects and lattice defects correlates with the amount of oxygen contained in cordierite. In order to make it possible to support the above-mentioned required amount of catalyst component, an amount of oxygen is preferably less than 47 percent by weight in the case of oxygen defects or more than 48 percent by weight in the case of lattice defects. When the amount of oxygen becomes less than 47 percent by weight by formation of oxygen defects, the number of oxygen atoms contained in a cordierite unit crystal lattice will become less than 17.2 and a grating constant of a crystal axis b₀ of cordierite will become smaller than 16.99. When the amount of oxygen increases to more than 48 percent by weight by formation of lattice defects, the number of oxygen atoms contained in a cordierite unit crystal lattice will increase more than 17.6 and a grating constant of a crystal axis b₀ of cordierite will become larger or smaller than 16.99.

A ceramic catalyst of the present invention is obtained by supporting a catalyst component on a surface of this direct-supporting ceramic carrier and, further, by supporting promoter components on it. Here, as shown in FIG. 1, a ceramic carrier 1 has many pores, and a catalyst component 2 and a promoter component 3a are supported preferably on inner surfaces of the pores as well as on outer surfaces of the carrier and on, for example, wall surfaces of cells in the case of honeycomb. In FIG. 1, a ceramic carrier 1 comprises, for example, cordierite containing non-component elements such as W, Co or the like. Catalyst components 2, such as noble metals, bond chemically to many atoms of the non-component element (not shown) existing on the surfaces (wall surfaces of cells and inner surfaces of pores). A plurality of promoter layers 3a, 3b are formed to cover the surfaces of the ceramic carrier 1.

As a catalyst component, a noble metal, for example, Pt, Rh, Pd, or the like, is used preferably. One of them may be used alone, or, if necessary, two or more of them may be used in combination. When a catalyst component bonds chemically to a surface of a ceramic carrier, a bonding strength is large. Therefore, heat deterioration is inhibited and heat resistance improves. As a result, a required amount of catalyst component can be smaller than a conventional catalyst which has a coated layers such as γ-alumina. Furthermore, a catalytic performance can be maintained for a long period of time. Besides, herein, in order to employ efficiently chemical bonding strengths between catalyst component noble metals and replacing non-component elements, a catalyst component is supported before a promoter component is. However, in order to increase initial performance, a catalyst component may be supported after a promoter component is supported. Of course, metallic elements other than noble metals can be used as a catalyst component.

Various materials can be used for a promoter component depending on purposes. For example, in a three way component catalyst for automobiles, a material having an oxygen storage capacity by which oxygen is moved in and out according to the fluctuation of surrounding oxygen concentration, hereinafter referred to as an OSC (oxygen storage component) material, is used. Examples of an OSC material include an oxide or multiple oxide containing at least one element selected from the group consisting of lanthanoids (La, Ce, Pr, Nd, Pm, Sm, Eu, Gd, Tb, Dy, Ho, Er, Tm, Yb, Lu), Y, Zr and Hf. Preferably an oxide or multiple oxide containing Ce, for example, ceria (CeO₂), a ceria/zirconia solid solution (CeO₂/ZrO₂) and the like, is used.

For example, CeO₂ has a Ce valence of 4+ when an oxygen concentration in the surrounding atmosphere is high, but it has a Ce valence of 3+ when an oxygen concentration in the surrounding atmosphere is low. The change of valence breaks electroneutrality. CeO₂ absorbs or desorbs oxygen to maintain electroneutrality. That is to say, CeO₂ has a function to adjust an air fuel ratio so that a catalytic performance may become the optimal by storage or release of oxygen. An oxygen storage capacity and heat resistance of an OSC material tend to be influenced by a content of Ce. For example, when a ceria/zirconia solid solution has a high content of Ce, namely, is Ce-rich, an oxygen storage capacity thereof is large but heat resistance thereof is small. On the contrary, when a ceria/zirconia solid solution has a low content of Ce, namely, is Zr-rich, heat resistance thereof is large but an oxygen storage capacity thereof is small.

Accordingly, this embodiment employs two layers of promoter components 3a, 3b. An innermost layer 3a contacting a catalyst component comprises a Ce-rich OSC material which has rather poor heat resistance but an excellent oxygen storage capacity. An outermost layer 3b comprises a Zr-rich OSC material having high heat resistance. When only one kind of promoter component 3 is used as shown in FIG. 2, it is necessary to increase a supported amount of a Ce-rich OSC material in order to keep a required oxygen storage capacity, and as a result a pressure drop and a heat capacity increase. On the other hand, when at least two layers of promoter components are employed as shown in FIG. 1, both a heat resistance and a catalytic performance can be improved without increasing an amount of supported promoter components. Moreover, preferably, a Ce-rich OSC material of an innermost layer 3a is supported mainly inside pores formed on a surface of a ceramic carrier, and a small amount of Ce-rich OSC material should be supported on an outer surface of a ceramic carrier, namely, on cell-wall surfaces of a ceramic carrier. Thus, by supporting a low heat-resistant OSC material inside the pores, a promoter component layer on the cell-wall surfaces can be made thinner as well as can be inhibited from peeling off. Moreover, the oxygen storage capacity can be exerted effectively since the OSC material is close to catalyst components on inner surfaces of the pores.

Many pores in a ceramic carrier are formed after a binder component burns away or some component contained in its raw material melts at the time of calcination. The pore generally has an average pore diameter of about 1 to 100 micrometers and a porosity of not less than 35 percent. A large average pore diameter is advantageous to increasing an amount of supported catalyst component. However, a too large average pore diameter makes the supported layer peel off easily. Moreover, a noble metal catalyst component having a small particle size enters into the pores easily. However, a promoter component, generally consisting of an oxide, such as an OSC material, must have a much smaller particle size than the pore diameter so that the promoter component may be supported inside the pores. Therefore, a pore diameter, a particle size of the catalyst component, porosity, and the like should be selected suitably so that a sufficient amount of catalyst component may be supported and also so that a promoter component layer may not peel off easily. A shape of pore is not limited, but a shape with its bottom wide like an ink bottle is not preferable because exhaust gas cannot penetrate easily and the catalytic efficiency deteriorates.

A total thickness of promoter layers formed on an outer surface (cell-wall surface) of a ceramic carrier is generally not more than 100 micrometers, preferably not more than 50 micrometers. The thinner the promoter layers are, the lower a pressure drop is. Generally an amount of supported promoter components is suitably selected in the range of 20 to 150 grams per liter. However, it is not limited to that range since an optimal value changes with kinds of promoter components and required characteristics. Each thickness, composition, and the like of an innermost layer comprising a low heat-resistant Ce-rich OSC material and a high heat-resistant Zr-rich OSC material also can be arbitrarily selected according to required characteristics. Moreover, a transition metal element which can bond strongly to the ceramic material may be added as a second component to the promoter components, and an element which has a heat-resistant improvement effect can also be added to a high heat-resistant OSC material.

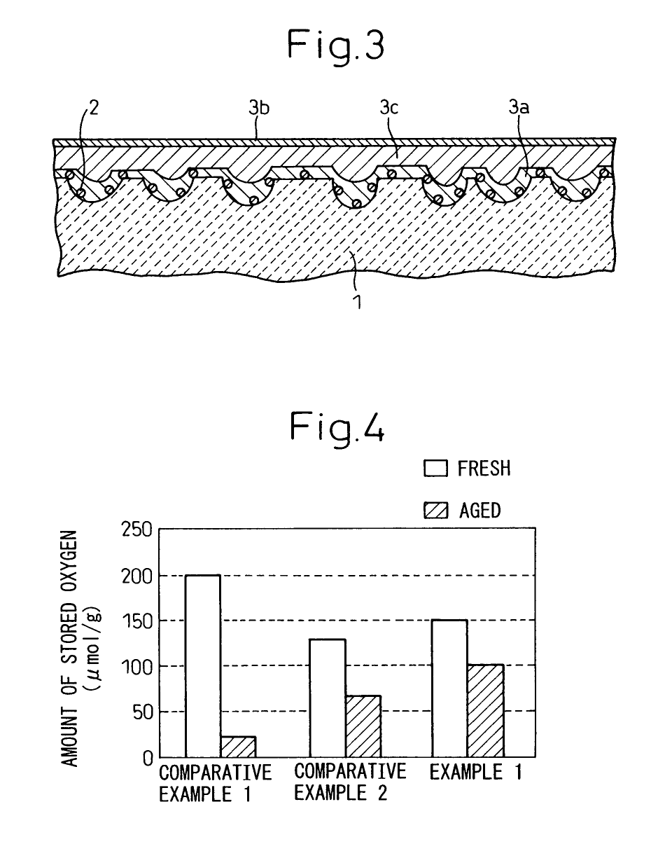

A ceramic catalyst may comprise three layers of promoter components as shown in FIG. 3 as a second embodiment. In this embodiment, an innermost layer 3a which contacts the catalyst component consists of CeO₂ excellent in oxygen storage capacity, and an intermediate layer 3c consisting of a Ce-rich OSC material is formed on the innermost layer 3a. Also, in this structure, heat resistance and an oxygen storage capacity can be secured without increasing an amount of supported promoter components by forming an outermost layer 3b of a high heat-resistant Zr-rich OSC material.

A catalyst component can be supported by a usual method as follows. An aqueous or alcoholic solution containing ions of a catalyst component is prepared, and the solution is impregnated into a ceramic carrier, which is dried and calcined. A preferred temperature of calcination is above a boiling point of the solvent and less than 1000 degrees centigrade. Calcination temperature of not less than 1000 degrees centigrade may cause degradation and therefore is not preferable. A slurry containing dispersed oxide particles of an OSC material can also be used in the case of a promoter component, and when a solution containing a precursor thereof is used, a particle size can be made smaller. Thereby, a predetermined amount of catalyst component can be supported without a coated layer of γ-alumina or the like. An amount of a supported catalyst component can be controlled by a concentration of a catalyst component in a solution. Solution impregnation and calcination steps may be repeated in order to increase an amount of a supported catalyst component.

When supporting promoter components, although it is preferable to support only OSC materials directly on a surface of a ceramic carrier from the viewpoint of decrease of a pressure drop or heat capacity, an OSC material may be supported together with a small amount of anchor coat material if heat resistance is regarded as more important. For example, by applying an anchor coat layer consisting of ceramics, such as alumina, silica, silica-alumina, and the like, having a larger specific surface area than the ceramic material of the ceramic carrier, a promoter layer of an OSC material can be held more stably, and heat resistance can be improved more while increase in a pressure drop or heat capacity is kept to the minimum.

### EXAMPLES

### Example 1

In order to demonstrate the effect of the present invention, a ceramic catalyst having a structure shown in FIG. 1 was prepared by the following method. First of all, talc, kaolin, alumina, and aluminum hydroxide were used as a raw material for cordierite. A mixture having an approximate stoichiometric composition of cordierite was prepared by replacing 10 percents of aluminum source with tungstic oxide having a valence different from Al. A binder, a lubricant, a moisturizer, and water were added in appropriate quantities to the mixture and kneaded to obtain a clay-like material. The clay-like material was molded into a honeycomb shape having a cell wall thickness of 100 micrometers, a cell density of 400 cpsi (cells per square inch) and a diameter of 50 millimeters. The obtained honeycomb-shaped molded solid was calcined at 1250 to 1390 degrees centigrade in atmospheric air to obtain a direct-supporting ceramic carrier consisting of a cordierite honeycomb structure.

In order to support noble metals as catalyst components on the ceramic carrier obtained as mentioned above, the ceramic carrier was immersed in an aqueous solution containing tetraammine platinum nitrate (0.05 moles per liter) and rhodium acetate (0.025 moles per liter). Then, it was taken out of the solution, and an excessive solution was removed. Thereafter, it was dried and calcined at 600 degrees centigrade in atmospheric air to change the nitrate and acetate into metals. The amounts of Pt and Rh supported as catalyst components were 1.0 and 0.2 grams per liter, respectively.

Subsequently, the ceramic carrier with Pt and Rh supported was immersed in a slurry containing dispersed Ce-rich ceria/zirconia solid solution particles having 75 percent of CeO₂ and 25 percent of ZrO₂ as a promoter component. Then, the immersed ceramic carrier was pulled up from the slurry and was dried. Thereafter, it calcined at 600 degrees centigrade in atmospheric air. The ceramic carrier was further immersed in the slurry containing dispersed Zr-rich ceria/zirconia solid solution particles having 72 percent of ZrO₂, 21 percent of CeO₂, 1.5 percent of La₂O₃, and 5.5 percent of Nd₂O₃. Then, the immersed ceramic carrier was pulled up from the slurry and was dried. Thereafter, it was calcined at 600 degrees centigrade in atmospheric air. Thus, a ceramic catalyst comprising Pt and Rh as catalyst components and two layers of promoter components which are a Ce-rich OSC material layer and a Zr-rich OSC material layer is obtained. La and Nd contained in Zr-rich OSC material were added in order to improve heat resistance. Such elements include Y, Pr, Ba, Al and the like in addition of La and Nd.

### Comparative Example 1

A ceramic catalyst was prepared by the same method as Example 1 except omitting a Zr-rich OSC material layer, provided that the amount of supported promoter component (Ce-rich OSC material) is the same as the total amount of supported promoter components (Ce-rich OSC material and Zr-rich OSC material) in Example 1.

### Comparative Example 2

A ceramic catalyst was prepared by the same method as Example 1 except omitting a Ce-rich OSC material layer, provided that the amount of supported promoter component (Zr-rich OSC material) is the same as the total amount of supported promoter components (Ce-rich OSC material and Zr-rich OSC material) in Example 1.

In order to evaluate the oxygen storage capacities and heat resistance of the ceramic catalysts of Example 1 and Comparative Examples 1 and 2, an amount of stored oxygen at fresh and an amount of oxygen stored after aging at 1000 degrees centigrade for 5 hours in atmospheric air were measured, respectively. The result was shown in FIG. 4. As shown in FIG. 4, the amount of stored oxygen at fresh in Comparative Example 1 using a Ce-rich OSC material was as large as 200 micromoles per gram, but the amount of oxygen stored after aging decreased remarkably. In Comparative Example 2 using a Zr-rich OSC material, decrease of amount of stored oxygen by aging was small, but an amount of stored oxygen at fresh was less than 150 micromoles per gram. On the other hand, the ceramic catalyst of Example 1 had an sufficiently large amount of stored oxygen at fresh, and the decrease of amount of oxygen stored after aging was very small. It shows that two layers of promoter components inhibited the ceramic catalyst from deteriorating.

As mentioned above, according to the present invention, as a ceramic catalyst comprises at least two layers of promoter components, an outermost layer of which is made of a highly heat-resistant material, it has a greatly improved heat resistance. Therefore, an innermost layer which contacts a catalyst component can be formed from a material having a higher promoter activity, and as a result both heat resistance and a catalytic performance can be achieved at a small amount of supported promoter components.

In addition, although the above-mentioned example illustrated a ceramic catalyst comprising an oxygen storage component as promoter components, various promoter components other than an oxygen storage component can be used depending on the application of the ceramic catalyst.

What is claimed is:

1. A ceramic catalyst comprising a ceramic carrier capable of supporting a catalyst component directly on a surface thereof, a catalyst component supported on a surface of the ceramic carrier, and at least two layers of promoter components formed on the ceramic carrier, wherein an outermost layer of the layers comprises a promoter component having the highest heat resistance among the promoter components.

2. A ceramic catalyst according to claim 1, wherein the ceramic carrier has many pores, and an innermost layer of the layers of promoter components is formed on inner surfaces of the pores.

3. A ceramic catalyst according to claim 1, wherein the ceramic carrier has many pores, and an innermost layer of the layers of promoter components is formed on inner surfaces of the pores as well as on an outer surface of the ceramic carrier.

4. A ceramic catalyst according to claim 1, wherein at least one of the promoter components comprises an oxygen storage component.

5. A ceramic catalyst according to claim 4, wherein the oxygen storage component is an oxide or multiple oxide comprising at least one element selected from the group consisting of lanthanoides, Y, Zr and Hf.

6. A ceramic catalyst according to claim 1, wherein the outermost layer of the layers of promoter components comprises a Zr-rich ceria/zirconia solid solution.

7. A ceramic catalyst according to claim 1, wherein an innermost layer of the layers of promoter components comprises a ceria or a Ce-rich ceria/zirconia solid solution.

8. A ceramic catalyst according to claim 1, comprising three layers of promoter components, wherein an innermost layer of the layers comprises a ceria, an intermediate layer of the layers comprises a Ce-rich ceria/zirconia solid solution, and an outermost layer of the layers comprises a Zr-rich ceria/zirconia solid solution.

9. A ceramic catalyst according to claim 1, wherein the ceramic carrier comprises a ceramic material, a part of atoms of at least one component element of the ceramic material are replaced by atoms of a non-component element, and the catalyst component is supported on the non-component element.

10. A ceramic catalyst according to claim 9, wherein the catalyst component is supported on the non-component element by chemical bond.

11. A ceramic catalyst according to claim 9, wherein the non-component element is at least one element having a d or f electron orbit.

12. A ceramic catalyst according to claim 1, wherein the ceramic carrier comprises a ceramic material selected from the group consisting of cordierite, alumina, spinel, mullite, aluminum titanate, zirconium phosphate, silicon carbide, zeolite, perovskite, and silica-alumina.

13. A ceramic catalyst according to claim 1, wherein the ceramic carrier has many cavities and the catalyst component can be supported directly in the cavities.

14. A ceramic catalyst according to claim 13, wherein the cavities comprise at least one of defects in a ceramic crystal lattice, fine cracks of ceramic surface, and deficiencies of atoms of component element of the ceramic material.

15. A ceramic catalyst according to claim 14, wherein the width of the fine cracks is not more than 100 nanometers.

16. A ceramic catalyst according to claim 13, wherein the cavities have a diameter or width of not more than 1000 times as long as that of an ion of the catalyst component supported, and there are not less than 1×10¹¹ cavities per liter.

17. A ceramic catalyst according to claim 14, wherein the ceramic material comprises cordierite, and the cavities comprise defects formed by replacing a part of component element of the cordierite with a metallic element having a different valence.

18. A ceramic catalyst according to claim 17, wherein the defects comprise at least one of oxygen defects and lattice defects, and the cordierite contains not less than 4×10⁻⁶ percents of cordierite crystals having at least one defect in a unit crystal lattice.

19. A ceramic catalyst according to claim 1, wherein the ceramic carrier is in at least one shape selected from the group consisting of honeycomb, pellet, powder, foam, fiber, and hollow fiber.
